(19) United States
(12) Patent Application Publication
(10) Pub. No.: US 2019/0303983 A1
(43) Pub. Date: Oct. 3, 2019

(54) SYSTEM AND PROCESS FOR DYNAMIC RENTAL PRICING OF INVENTORY AT SPORTING AND ENTERTAINMENT FACILITIES

(71) Applicant: FLYINGTEE TECH, LLC, Jenks, OK (US)

(72) Inventors: JAMES VOLLBRECHT, JENKS, OK (US); JEREMY MATHEW CARVER, MILLCREEK, UT (US); JOHN VOLLBRECHT, JENKS, OK (US)

(73) Assignee: FLYINGTEE TECH, LLC, JENKS, OK (US)

(21) Appl. No.: 16/372,170

(22) Filed: Apr. 1, 2019

Related U.S. Application Data
(60) Provisional application No. 62/650,757, filed on Mar. 30, 2018.

(51) Int. Cl. G06Q 30/02; G06Q 30/06; G06Q 10/08

(52) U.S. Cl. CPC G06Q 30/0283; G06Q 10/087; G06Q 30/0202; G06Q 30/0645

(57) ABSTRACT

This invention relates to a system and process for dynamic rental pricing of inventory at sporting and entertainment facilities, namely multi-level, multi-bay golf entertainment facilities. In one aspect, the invention electronically provides for a predetermined reduced price for guests to continue to utilize inventory after their original purchased time has expired using an algorithmic process based on a real-time waitlist and/or future inventory usage based on reservations, group events, etc. In another aspect, the invention electronically adjusts inventory pricing in real-time based on the percent of inventory that is reserved versus available for a given day, date and/or time of day.

### CROSS REFERENCE TO RELATED APPLICATIONS

The application claims the benefit of and priority to U.S. Provisional Patent Application No. 62/650,757, filed Mar. 30, 2018, and incorporates by reference said provisional application in its entirety.

### BACKGROUND OF THE INVENTION

### 1. Field of the Invention

This invention generally relates to a system and process for dynamic rental pricing of inventory at sporting and entertainment facilities, such as multi-level, multi-bay golf entertainment facilities.

### 2. Description of the Related Art

The game of golf has remained a popular hobby and recreational activity since it was invented several centuries ago. Part of the popularity of golf comes from pursuing mastery of its various skills. Improving such skills requires frequent and consistent practice. Driving ranges are common venues used for such practice. At typical driving ranges, golfers can practice their swing. Recently, advanced driving ranges have opened that combine traditional practice with entertainment and recreation. Such facilities include not only the typical driving range, but also restaurants, bars, and other entertainment options with which the golfer may choose to supplement their practice round.

Generally bays at golfing and activities at entertainment facilities (e.g., bowling allies, laser tag, ropes courses, skating rinks, movie theaters, or other entertainment facility that books physical space for entertainment or sports) are priced manually based on inventory for the activities, game play and/or inventory-type (e.g., size, level and furniture), by time of day, and/or by day of week. In addition, premium pricing can generally be charged for inventory reserved with twelve (12) hours of advance notice. However, operators of such facilities have no system to price inventory based on real-time supply and demand of inventory. Additional price points that are logic-driven will help the facility operator maximize utilization while also protecting inventory during periods of high demand.

Accordingly, there is a need for a system and process for dynamic rental pricing of inventory at sporting and entertainment facilities that can price and re-price inventory for game play and other activities at near-real-time without need for human intervention. The invention disclosed herein is focused on solving such long-felt needs in near-real time and providing the techniques to thereby fulfill those needs.

It is therefore desirable to provide a system and process for dynamic rental pricing of inventory at sporting and entertainment facilities.

It is further desirable to provide a system and process for dynamic rental pricing of inventory at sporting and entertainment facilities that electronically provides for a reduced price for guests to continue to utilize inventory before and/or after their original purchased time has expired using an algorithmic processes based on a real-time waitlist, progress in current game, customer value to the business (e.g., based on average spend, frequency of visits, etc.) and/or future bay inventory usage based on reservations, group events, etc.

It is still further desirable to provide a system and process for dynamic rental pricing of inventory at sporting and entertainment facilities that electronically adjusts inventory pricing in real-time based on the percent of inventory that is reserved versus available for a given day, date and/or time of day.

Before proceeding to a detailed description of the invention, however, it should be noted and remembered that the description of the invention which follows, together with the accompanying drawings, should not be construed as limiting the invention to the examples (or embodiments) shown and described. This is so because those skilled in the art to which the invention pertains will be able to devise other forms of this invention within the ambit of the appended claims.

### SUMMARY OF THE INVENTION

In general, the invention relates to a system and process dynamic rental pricing of inventory at sporting and entertainment facilities providing a market-clearing price for available inventory given the real-time demand for such inventory. In one aspect, the invention electronically provides for a reduced price for guests to continue to rent the inventory after their original purchased time has expired using an algorithmic process based on a real-time waitlist and/or future known or expected inventory usage based on reservations, group events, etc. In another aspect, the invention electronically adjusts inventory pricing in real-time based on the percent of inventory that is reserved versus available for a given day, date and/or time of day. In another aspect, the invention electronically adjusts the price of inventory by increasing it if the facility has a wait-time of over a predetermined amount of time, such as one (1) hour for a golf bay.

The foregoing has outlined in broad terms some of the more important features of the invention disclosed herein so that the detailed description that follows may be more clearly understood, and so that the contribution of the instant inventors to the art may be better appreciated. The instant invention is not to be limited in its application to the details of the construction and to the arrangements of the components set forth in the following description or illustrated in the drawings. Rather, the invention is capable of other embodiments and of being practiced and carried out in various other ways not specifically enumerated herein. Finally, it should be understood that the phraseology and terminology employed herein are for the purpose of description and should not be regarded as limiting, unless the specification specifically so limits the invention.

### BRIEF DESCRIPTION OF THE DRAWINGS

These and further aspects of the invention are described in detail in the following examples and accompanying drawings.

FIG. 1 is a flow chart illustrating an overview of the system and process for dynamic rental pricing in accordance with an illustrative embodiment of the invention disclosed herein.

FIG. 2 is a flow chart illustrated the system inputs and outputs of the system and process for dynamic rental pricing in accordance with an illustrative embodiment of the invention disclosed herein.

FIG. 3 is a flow chart illustrating an example of a dynamic rental pricing calculation in accordance with an illustrative embodiment of the invention disclosed herein.

### DETAILED DESCRIPTION OF THE INVENTION

While this invention is susceptible of embodiment in many different forms, there is shown in the drawings, and will herein be described hereinafter in detail, some specific embodiments of the instant invention. It should be understood, however, that the present disclosure is to be considered an exemplification of the principles of the invention and is not intended to limit the invention to the specific embodiments or algorithms so described.

The invention relates to a system and process dynamic rental pricing of inventory at sporting and entertainment facilities. In one aspect, the invention electronically provides for a reduced price for guests to continue to use inventory at the facility after their original purchased time has expired using an algorithmic process based on a real-time waitlist and/or future inventory usage based on reservations, group events, etc. A computer or software service calculates a view of inventory and remaining open hours in the day as set by a system administrator. If open inventory exceeds a predetermined percentage at the time of the price request (e.g., 50%), the system and process would algorithmically reduce the price for inventory extensions within preset system limits, and this reduced price would be electronically presented to the guests after original purchased time has expired allowing the guests to continue use the inventory for game play or other activities at the reduced price rate.

Moreover, the system and process can be configured to electronically calculate the reduced-price rate to continue inventory usage based upon a number of different user and/or environmental variables. By way of example and not limitation and assuming that a standard inventory pricing represents 1×, the system and process could electronically provide at a predetermined reduced rate (e.g., 0.5× rate) if there is inclement weather and a relatively large surplus of available inventory. Further, the system and process could also electronically provide inventory time to be purchased as “play until close” at a predetermined rate (e.g., 1× for three hours of inventory time, or 0.33× per hour) if there is a large surplus of inventory available. Yet further, the system and process may electronically provide additional inventory time for the players to complete their current game depending on the particular type of game play and the amount of play in the game remaining; for example, if the players are in an unfinished game when time expires, completion of the game could be offered at a flat rate, determined as a factor of the base price 1×. The reduced rate would vary depending on the relative shortage or surplus of inventory as determined by the computer in real-time. In addition, the system and process may be configured to electronically provide different inventory time prices based on the guest and guest behavior, such as the guests purchase of food, beverage or other tangible items. For example, if a group has spent $50 or more on food and beverages per person, the system and process can electronically offer additional time at the reduced rate (e.g., 0.1×). In another aspect, the system and process can be configured to offer the guest a reduced rate on their first visit, or if they have visited a requisite number of times in the past 30 days.

In another aspect, the invention electronically adjusts inventory pricing in real-time based on the percent of inventory that is reserved versus available for a given day, date and/or time of day. The computer of the system and process monitors the inventory reserved by the public relative to the inventory made available for reservation (available inventory) in real-time. For example, if a predetermined percent or less of available-for-reservation inventory is reserved 48 hours prior to the day in question, the system may generate a reduced price for reservations on that day. In this event, the system and process could generate and electronically send a notification to a predetermined set of guests (e.g., VIPs, frequent or heavy users, pre-paid members, etc.) alerting them to the reduced price. Alternatively, the price for inventory may be reduced below a standard retail rate if the reservation meets certain criteria (e.g., low-utilization hours such as the hour after opening, if the reservation is for 4 or more hours).

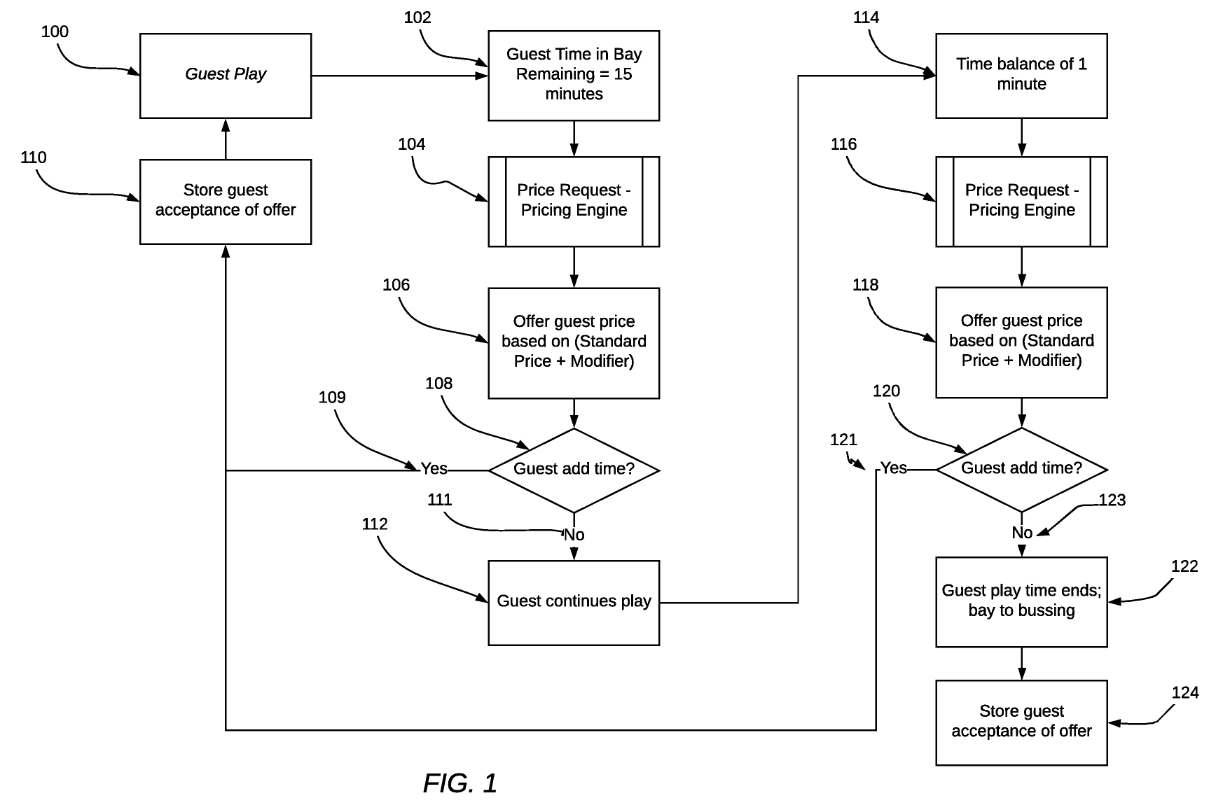

Referring now to FIG. 1, the illustrated flow chart exemplifies the inventive system and process for dynamic rental pricing in connection with a golf bay rental at a golf and entertainment facility. A guest is utilizing inventory at the facility for game play or another activity (step 100) and when a first predetermined amount of time is remaining on the guest's session (e.g., 15 minutes) (step 102), the system and process for dynamic rental pricing determines the guest's inventory status and game play state (step 104). The inventive system and process then offers the guest a first reduced-price rate based on a real-time waitlist, progress in current game, customer value to the business (e.g., based on average spend, frequency of visits, etc.) and/or future bay inventory usage based on reservations, group events, etc. (step 106). The guest can then elect to accept the first reduced-price rate in order to continue to utilize the bay inventory for an additional amount of time (step 109), in which case the system stores the guest's acceptance of the offer in a database (step 110. If the guest declines the first reduced-price rate (step 111), the guest can continue to use the bay inventory for the remainder of the guest's initial session (step 112).

When a second predetermined amount of time is remaining on the guest's initial session (e.g., 1 minute) (step 114), the system and process for dynamic rental pricing reassess the guest's inventory status and game play state (step 116). The inventive system and process offers the guest a second reduced-price rate based again on a real-time waitlist, progress in current game, customer value to the business (e.g., based on average spend, frequency of visits, etc.) and/or future bay inventory usage based on reservations, group events, etc. (step 118). Similar to step 108, the guest can elect to accept the second reduced-price rate in order to continue to utilize the bay inventory for an additional amount of time (step 121), in which case the system stores the guest's acceptance of the offer in a database (step 110). If the guest declines the second reduced-price rate (step 123), the guest can continue to use the bay inventory for the remainder of the guest's initial session (step 112) and the system stores the guest's rejection of the offer in the database (step 124). It should be understood that the process for dynamic rental pricing can repeat and loop for additional amounts of time remaining on the guest's session of use of the inventory.

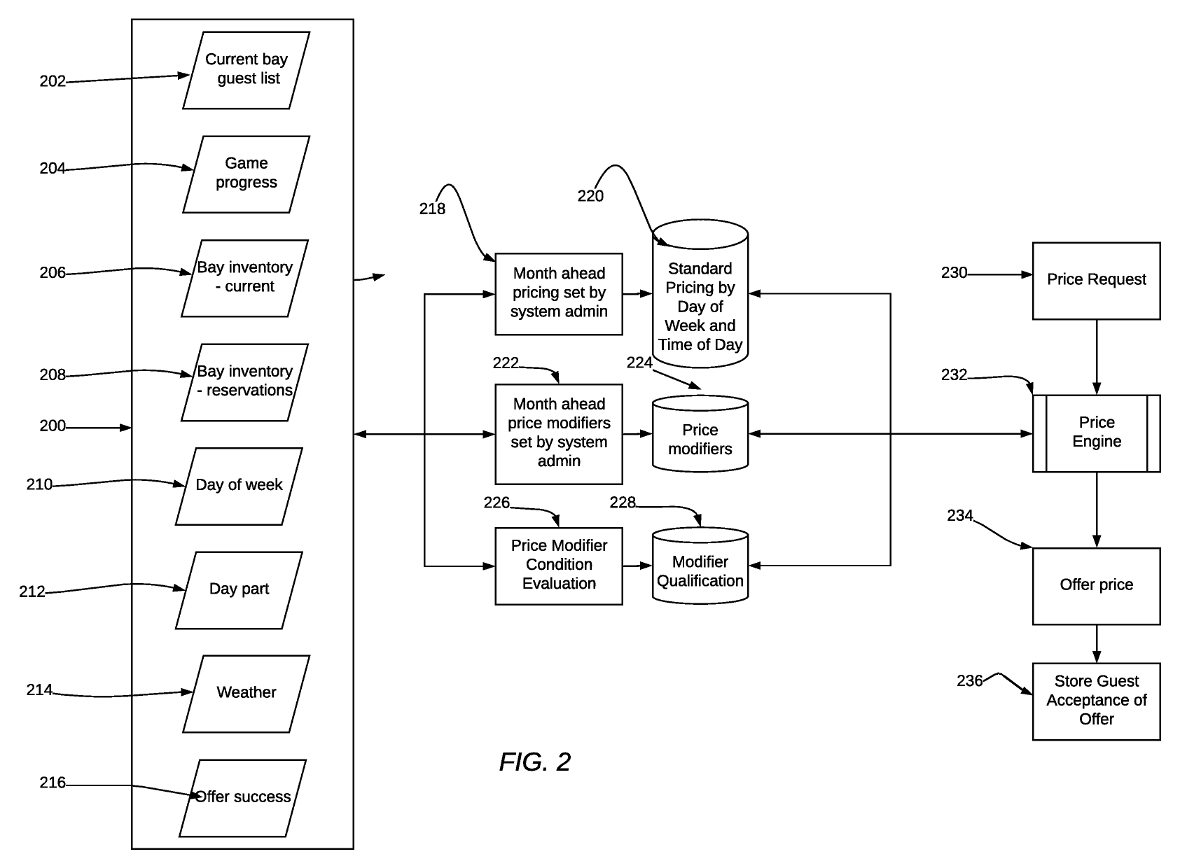

FIG. 2 illustrates a flow chart of the inputs and outputs of the inventive system and process for dynamic rental pricing disclosed herein. As exemplified, the inputs of the system are stored in a database (200) and can include current bay guest list(s) (202), the progress of the user's current game session (204), current bay inventory for the facility (206), future bay inventory for the facility based on reservations, group events, etc. (208), specified pricing for a particular day(s) of the week (210), specified pricing for a particular time(s) of day (212), weather conditions (214), and previous offer acceptances/rejections for the particular guest (216). Various price modifiers are stored in the system and can include month ahead pricing set by a system administrator (218) that is communication with a database of standard pricing by day of the week and time of the day (220), month ahead price modifiers set by the system administrator (222) that is in communication with a database of price modifiers (224), and/or price modifier condition evaluation logic (226) that is in communication with a database of modifier qualifications (228).

In communication with the modifier databases and processes, the inventive system for dynamic rental pricing includes a price request module (230) that is controlled by the price engine (232). The price engine (232) determines the guest's current session and state and accordingly offers the guest a reduced-price rate based on the price modifier conditions (218-228). In addition, the system stores the guest's acceptance or rejection of the modified pricing offer in a database (236).

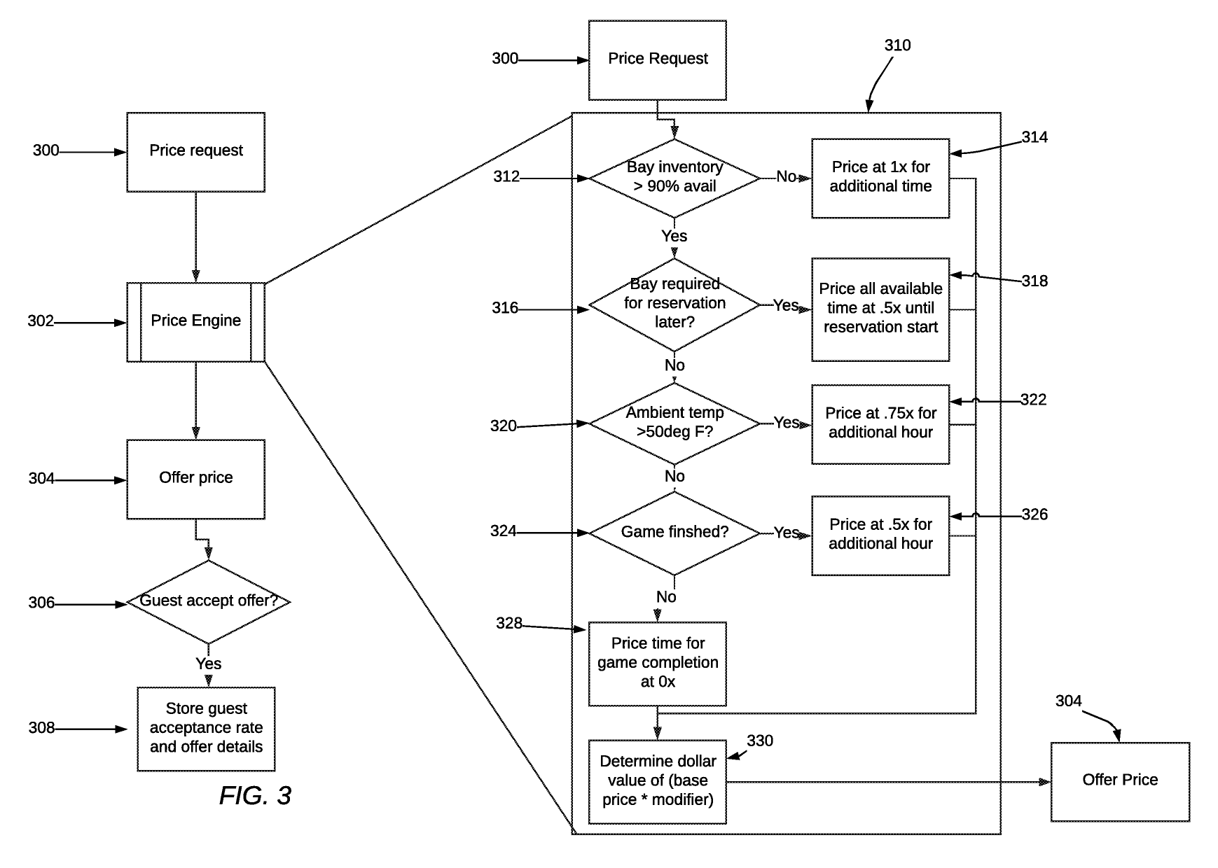

FIG. 3 is a flow chart illustrating an example of a dynamic rental pricing calculation, and as noted above, the inventive system for dynamic rental pricing includes a price request module (300) that is controlled by the price engine (302). The price engine (302) determines the guest's current session and state and accordingly offers (306) the guest a reduced-price rate based on the price modifier logic (310). In addition, the system stores the guest's acceptance or rejection of the modified pricing offer in a database (308).

As illustrated in FIG. 3, in response to a price request (step 300), the inventive system and process determines in real-time the bay inventory of the facility (step 312). If bay inventory is in excess of a predetermined amount (e.g., bay inventory >90% available) step (312), the system offers the guest additional time to use the bay inventory for a rate equal to the guest's initial session (step 314). If, however, bay inventory is below the predetermined amount, the system then determines future bay inventory usage based on reservations, group events, etc. (step 316). If future bay inventory is available, the system offers the guest a predetermined reduced rate (e.g., 0.5×) until the future bay reservations or group events are scheduled to begin (step 318). If the bay inventory is not scheduled for future reservations or group events, the system and process could electronically provide at a predetermined reduced rate (e.g., 0.75× for an additional hour) if there is inclement weather or weather below a certain ambient temperature (step 320, 322). If there are no weather conditions and future bay inventory is available, the system can then electronically determine whether the guest's initial game play and/or activity session is at or near completion (step 324). If the foregoing is true, the system can electronically provide the user a predetermined reduced rate (e.g., 0.5× for an additional hour) (step 326); if the foregoing is false, the system can electronically provide the guest with the option to extend the original session without a reduced rate (step 328). Based on the based on the price modifier logic (310) detailed above, the system can then determine a dollar value attributable to the guest based on the base price plus any predetermined reduced rates offered to the guest (step 330). The guest acceptance rate and offer details are stored in the system (step 308) so that guest value to the business (e.g., based on average spend, frequency of visits, etc.) can be tracked and utilized for future guest visits to the facility.

Moreover, the system and process for dynamic rental pricing can electronically evaluate the effectiveness of guest offers, and should the past predetermined number of offers (e.g., 10) of the same kind be rejected, the system may reconfigure the offer to be a lower predetermined reduced rate. Corresponding, if the past predetermined number of offers (e.g., 10) of the same kind are accepted, the system may electronically provide the guest with a higher predetermined reduced rate.

As used herein, the term “inventory” may refer, but is not limited to a physical space (e.g., a bay at a golf entertainment facility, a lane at a bowling alley, a seat at a movie theater, etc.) that is rented or paid for a preterminal amount of time.

As used herein, the term “guest” or “user” are used to refer to individuals that are requesting or utilizing inventory in the sporting and entertainment facility.

As used herein, the term “computer” may refer, but is not limited to a laptop or desktop computer, or a mobile device, such as a desktop, laptop, tablet, cellular phone, smart phone, personal media user (e.g., iPod), wearable computer, implantable computer, or the like. Such computing devices may operate using one or more operating systems, including, but not limited to, Windows, MacOS, Linux, Unix, iOS, Android, Chrome OS, Windows Mobile, Windows CE, Windows Phone OS, Blackberry OS, and the like.

As used herein, the term “mobile device” may refer, but is not limited to any computer, as defined herein, that is not fixed in one location. Examples of mobile devices include smart phones, personal media users, portable digital assistants, tablet computers, wearable computers, implanted computers, and laptop computers.

The system and process described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The systems and/or processes described herein, and steps thereof, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium.

The systems and/or processes described herein provide that methods, techniques, and actions performed by a computer or computing device are performed programmatically, or as a computer-implemented method. Programmatically, as used herein, means through the use of code or computer-executable instructions. These instructions can be stored in one or more memory resources of the computing device. A programmatically performed step may or may not be automatic.

The systems and/or processes described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Thus, in one aspect, each process described above and combinations thereof may be embodied in computer executable code that, when executing on one or more computing devices, performs the steps thereof. In another aspect, the processes may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

It is to be understood that were the specification or claims refer to relative terms, such as “front,” “rear,” “lower,” “upper,” “horizontal,” “vertical,” “above,” “below,” “up,” “down,” “top,” “bottom,” “left,” and “right” as well as derivatives thereof (e.g., “horizontally,” “downwardly,” “upwardly” etc.), such reference is used for the sake of clarity and not as terms of limitation, and should be construed to refer to the orientation as then described or as shown in the drawings under discussion. These relative terms are for convenience of description and do not require that the apparatus be constructed or the process to be operated in a particular orientation.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Processes of the instant disclosure may be implemented by performing or completing manually, automatically, or a combination thereof, selected steps or tasks.

The term “process” may refer to manners, means, techniques and procedures for accomplishing a given task including, but not limited to, those manners, means, techniques and procedures either known to, or readily developed from known manners, means, techniques and procedures by practitioners of the art to which the invention belongs.

It should be noted that where reference is made herein to a process comprising two or more defined steps, the defined steps can be carried out in any order or simultaneously (except where context excludes that possibility), and the process can also include one or more other steps which are carried out before any of the defined steps, between two of the defined steps, or after all of the defined steps (except where context excludes that possibility).

Still further, additional aspects of the instant invention may be found in one or more appendices attached hereto and/or filed herewith, the disclosures of which are incorporated herein by reference as if fully set out at this point.

Thus, the present invention is well adapted to carry out the objects and attain the ends and advantages mentioned above as well as those inherent therein. While the inventive concept has been described and illustrated herein by reference to certain illustrative embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. A process for dynamic rental pricing of inventory at a sporting and entertainment facility, the process being performed on one or more processors and comprising the steps of:
determining a first predetermined amount of time remaining on an inventory session at said facility;
then, electronically offering a first reduced-price rate for a first additional rental time period based on one or more real-time price modifier conditions;
then, electronically capturing and storing an acceptance or a rejection of said first reduced-price rate;
if said first reduced-price rate is accepted, electronically continuing said inventory session at said facility for said first additional rental time period;
if said first reduced-price rate is rejected, determining a second predetermined amount of time remaining on said inventory session at said facility;
then, electronically offering a second reduced-price rate for a second additional rental time period based on said one or more real-time price modifier conditions;
then, electronically capturing and storing an acceptance or a rejection of said second reduced-price rate;
if said second reduced-price rate is accepted, electronically continuing said inventory session at said facility for said second additional rental time period;
if said second reduced-price rate is rejected, terminating said inventory session at said facility upon competition.

2. The process of claim 1 further comprising the step of electronically storing said acceptance or said rejection of said first reduced-price rate.

3. The process of claim 1 further comprising the step of electronically storing said acceptance or said rejection of said second reduced-price rate.

4. The process of claim 1 wherein said one or more real-time price modifier conditions comprises a real-time inventory for said facility, a real-time progress of said inventory session at said facility, a guest value for renting said inventory session at said facility, a future inventory usage at said facility based on reservations and/or group events, a particular time of day, a particular day of week, a particular time of year, real-time weather conditions, previous offer acceptances or rejections for a particular guest at said facility, or a combination thereof.

5. A computer-implemented process for adjusting a rental pricing rate of a bay inventory at a golf and entertainment facility, the process comprising the steps of:
electronically determining a reduced rental pricing rate for said bay inventory at said facility based on one or more real-time price modifier conditions;
electronically adjusting said rental pricing rate of said bay inventory in real-time to said reduced rental pricing rate based on said one or more real-time price modifier conditions.

6. The computer-implemented process of claim 5 further comprising the step of electronically determining in real-time a percent of said bay inventory available at said facility.

7. The computer-implemented process of claim 5 wherein said step of electronically determining further comprises the step of electronically determining said reduced rental pricing rate for said bay inventory at said facility based on a percent of said bay inventory that is reserved versus available for a given day, a given date, a given time of day, or a combination thereof.

8. The computer-implemented process of claim 5 wherein said one or more real-time price modifier conditions comprises a real-time inventory for said facility, a real-time progress of said inventory session at said facility, a guest value for renting said inventory session at said facility, a future inventory usage at said facility based on reservations and/or group events, a particular time of day, a particular day of week, a particular time of year, real-time weather conditions, previous offer acceptances or rejections for a particular guest at said facility, or a combination thereof.

9. The computer-implemented process of claim 5 wherein said golf and entertainment facility is a multi-level, multi-bay golf and entertainment facility.

10. A computer system for adjusting a rental pricing rate of a bay inventory at a golf and entertainment facility, the computer system comprising:
a display;
one or more wireless communication interfaces;
one or more memory resources; and
one or more processors to:
electronically determining a reduced rental pricing rate for said bay inventory at said facility based on one or more real-time price modifier conditions;
electronically adjusting said rental pricing rate of said bay inventory in real-time to said reduced rental pricing rate based on said one or more real-time price modifier conditions.

11. The computer system of claim 10 further comprising the step of electronically determining in real-time a percent of said bay inventory available at said facility.

12. The computer system of claim 10 wherein said step of electronically determining further comprises the step of electronically determining said reduced rental pricing rate for said bay inventory at said facility based on a percent of said bay inventory that is reserved versus available for a given day, a given date, a given time of day, or a combination thereof.

13. The computer system of claim 10 wherein said one or more real-time price modifier conditions comprises a real-time inventory for said facility, a real-time progress of said inventory session at said facility, a guest value for renting said inventory session at said facility, a future inventory usage at said facility based on reservations and/or group events, a particular time of day, a particular day of week, a particular time of year, real-time weather conditions, previous offer acceptances or rejections for a particular guest at said facility, or a combination thereof.

14. The computer system of claim 10 wherein said golf and entertainment facility is a multi-level, multi-bay golf and entertainment facility.

15. A non-transitory computer-readable medium storing instructions that, when executed by one or more processors, cause the one or more processors to:
determine an initial predetermined amount of time remaining on an inventory session at a golf and entertainment facility;
then, electronically offer an initial reduced-price rate for an initial additional rental time period based on one or more real-time price modifier conditions;
then, electronically capture and store an acceptance or a rejection of said initial reduced-price rate;
if said first reduced-price rate is accepted, electronically continue said inventory session at said facility for said initial additional rental time period;
if said first reduced-price rate is rejected, determine a subsequent predetermined amount of time remaining on said inventory session at said facility;
then, electronically offer a subsequent reduced-price rate for a subsequent additional rental time period based on said one or more real-time price modifier conditions;
then, electronically capture and store an acceptance or a rejection of said subsequent reduced-price rate;
if said subsequent reduced-price rate is accepted, electronically continue said inventory session at said facility for said subsequent additional rental time period;
if said subsequent reduced-price rate is rejected, terminating said inventory session at said facility upon competition.

16. The non-transitory computer-readable medium claim 15 further comprising the step of electronically storing said acceptance or said rejection of said initial reduced-price rate.

17. The non-transitory computer-readable medium claim 15 further comprising the step of electronically storing said acceptance or said rejection of said subsequent reduced-price rate.

18. The non-transitory computer-readable medium claim 15 wherein said one or more real-time price modifier conditions comprises a real-time inventory for said facility, a real-time progress of said inventory session at said facility, a guest value for renting said inventory session at said facility, a future inventory usage at said facility based on reservations and/or group events, a particular time of day, a particular day of week, a particular time of year, real-time weather conditions, previous offer acceptances or rejections for a particular guest at said facility, or a combination thereof.

19. The non-transitory computer-readable medium of claim 15 wherein said golf and entertainment facility is a multi-level, multi-bay golf and entertainment facility.
